(19) United States
(12) Patent Application Publication
(10) Pub. No.: US 2005/0063542 A1
(43) Pub. Date: Mar. 24, 2005

(54) Method of generating an encryption key without use of an input device, and apparatus therefor

(76) Inventor: Jun-young Ryu, Neongnam-si (KR)

Correspondence Address: STANZIONE & KIM, LLP, 1740 N STREET, N.W., FIRST FLOOR, WASHINGTON, DC, 20036, US

(21) Appl. No.: 10/914,083

(22) Filed: Aug. 10, 2004

(30) Foreign Application Priority Data
Aug. 13, 2003 (KR) 2003-56007

(51) Int. Cl. H04L 9/00

(52) U.S. Cl. 380/259; 380/44

(57) ABSTRACT

A method of generating an encryption key in a host system that transmits an encrypted signal. The encryption key generating method can be used in a host system that doesn't have an input device such as a keyboard or mouse. The encryption key generating method can be used in a network environment having a host system that can transmit an encrypted signal and a client system that can receive and accept the encrypted signal by using an encryption key determined in the host system. The method can include the acts of reading a pre-designated number of the host system, reading a current value of a dip switch installed in the host system, associating the pre-designated number with the current value, and generating an encryption key in a wireless LAN environment by using the associated value. Since the encryption key generating method generates an encryption key by using the pre-designated number of the host system which is unique to each system and not externally exposed, and also increases the number of possible encryption keys by using the dip switch, increased security can be achieved.

### CROSS-REFERENCE TO RELATED APPLICATIONS

This application claims the priority of Korean Patent Application No. 2003-56007, filed on 13 Aug. 2003, in the Korean Intellectual Property Office, the disclosure of which is incorporated in its entirety by reference.

### BACKGROUND OF THE INVENTION

1. Field of the Invention

The present invention relates to an apparatus and method of generating an encryption key in a host system that transmits an encrypted signal. More particularly, the present invention relates to an apparatus and method of generating an encryption key in a host system that does not have an input device such as a keyboard or a mouse.

2. Description of the Related Art

In general, encryption is performed to prevent transmitted data from being read, copied or falsified by an external intruder. The encrypted data is received at a reception end, and restored into original data by way of decryption.

Recently, in order to strengthen the relatively weak security of wireless LANs (Local Area Networks) compared to wired LANs, the IEEE 802.11 standard proposed an encryption method called WEP (Wired Equivalent Privacy).

WEP provides a mechanism to protect a datastream in a wireless LAN where both a transmission end and a reception end use a symmetrical algorithm that encrypts or decrypts data by using an identical encryption key and algorithm.

WEP uses an encryption key called a WEP key having 40 to 128 bits. WEP provides a method of refusing access to a wireless device not having an identical WEP key, a method of grouping wireless devices having an identifier called SSID (Service Set ID), and so on. Accessing methods in WEP are disclosed in Japanese Laid-open Patent Publication No. 2001-111543 on Apr. 20, 2002, Japanese Laid-open Patent Publication No. 2001-111544 on Apr. 20, 2002, U.S. Laid-open Patent Publication No. US2003/0051132 on May 13, 2003, and PCT International Patent Publication W002/084917 on Oct. 24, 2002.

Generally, manufacturers of wireless communications devices temporarily set WEP key at the time of shipment. An entire product line made by a particular manufacturer can have the same temporarily set WEP key. This occurs because manufacturers assume that users will set their own encryption key. However, users may not set their own encryption key in actual circumstances of using the wireless communications device, and accordingly, communications with unauthorized people, or leakage of secrete information, may occur. In a computer system having an input device such as, for example, a keyboard or a mouse, a user can set a WEP key by using the input device. However, in a system that doesn't have an input device, for example, in the case of a set-top-box, a user cannot set a WEP key. As a result, a signal transmitted from the set-top-box can be viewed by an unauthorized person.

Moreover, WEP is based on an RC4 encryption algorithm of an RCA data system. The encryption algorithm is generated on the basis of a key (a WEP key having a series of numerals) which is controlled and input by a user. Such an RC4 algorithm is based on a key scheduling algorithm. However, the key scheduling algorithm is more vulnerable to hacking than a block sequence. Thus, the ability to alter a WEP key as desired is advantageous even in a system that doesn't have an input device.

FIG. 1 is a block diagram showing a configuration of a conventional encryption apparatus using wired equivalent privacy (WEP), which is disclosed in Japanese Laid-open Patent Publication No. 2001-111543.

As shown in FIG. 1, an encryption apparatus includes a seed generator 102 which receives an initialization vector and an encryption key (WEP key) and generates a seed, a WEP random generator 104 which generates a key sequence by using the seed generated in the seed generator 102, a check value generator 108 which generates an integrity check value by using an original document to be transmitted and an integrity document generated in an integrity generator 106 which receives the original document, an XOR gate 110 which exclusively ORs the key sequence and the check value and generates an encryption document, and a packet transmitter 112 which adds the initialization vector to the encryption document generated in the XOR 110 to thereby transmit a packet.

The initialization vector of the packet generated in the process of encryption is not encrypted. Thus, the initialization vector can be used when a receiver at a reception end makes the same key sequence as that of the transmission end.

FIG. 2 is a block diagram showing a configuration of a conventional decryption apparatus using wired equivalent privacy (WEP).

As shown in FIG. 2, the conventional decryption apparatus includes a seed generator 204 which receives an initialization vector of a packet received via a packet receiver 202 and the encryption key (WEP key), and generates a seed; a WEP random generator 206 which generates a key sequence by using the seed generated in the seed generator 204; an XOR gate 208 which exclusively ORs the key sequence generated in the WEP random generator 206 and the encryption document of the received packet; a decryptor 210 which decrypts the XORed key sequence and encryption document into an encryption document and a check value; and a comparator 214 which compares the decrypted check value with a check value generated in an integrity generator 212 to confirm whether or not both check values are equal.

The encryption key is designated by a manufacturer at the time of shipment of the products to market. The SSID and WEP keys are provided in printed form on the product or in a manual. In a system that doesn't have an input device, the network configuration is performed by the SSID and WEP keys designated by the manufacturer.

FIG. 3 is a flowchart showing a conventional network configuration method for establishing an encryption key in a host system that doesn't have an input device. First, when the host system is booted, the network configuration is performed by the SSID and WEP keys designated by the manufacturer (S302).

Similarly, a client system also performs the network configuration by the SSID and WEP keys designated by the manufacturer. For the purpose of performing the network configuration, a user inputs the SSID and WEP keys designated by the manufacturer to the client system via an input device (S304).

If the network configuration has been performed in the client system, a host system is accessed (S306 and S308).

In this configuration, because there is no input device for establishing a WEP key, the host system accomplishes a network configuration by the SSID and WEP keys designated by the manufacturer. However, since the SSID and WEP keys designated by the manufacturer are provided in printed form on the product or in a manual, they may be used by an unauthorized person.

Moreover, as disclosed above, WEP is based on an RC4 encryption algorithm of an RCA data system. The encryption algorithm is generated on the basis of a key which is controlled and input by a user (a WEP key having a series of numerals). Such an RC4 algorithm is based on a key scheduling algorithm. However, such a key scheduling algorithm is more vulnerable to hacking than a block sequence.

### SUMMARY OF THE INVENTION

To solve the above and/or other problems, it is an aspect of the present invention to provide an encryption key generating method capable of maintaining security even in a system that doesn't have an input device.

It is another aspect of the present invention to provide an apparatus that can generate an encryption key.

Additional aspects and advantages of the invention will be set forth in part in the description which follows and, in part, will be obvious from the description, or may be learned by practice of the invention.

The foregoing and/or other aspects of the present invention are achieved by providing an encryption key generating method that can operate in a network environment having a host system transmitting an encrypted signal and a client system which receives the encrypted signal transmitted from the host system and decrypts the received signal by using an encryption key established in the host system. The encryption key generating method can include the operations of: reading a pre-designated number corresponding to the host system; reading a current value of a dip switch installed in the host system; associating the pre-designated number with the current value; and generating an encryption key in a wireless LAN environment by using the associated value.

The foregoing and/or other aspects of the present invention may also be achieved by providing an encryption key generating apparatus having a host system transmitting an encrypted signal and a client system which receives the encrypted signal transmitted from the host system and decrypts the received signal by using an encryption key established in the host system to thereby generate a network encryption key. The encryption key generating apparatus may include: a memory storing a pre-designated number corresponding to the host system; a dip switch installed in the host system; and an encryption key generator that receives the pre-designated number corresponding to the host system and a current value of the dip switch, and generates an encryption key that the host system uses to setup a network.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a block diagram showing a configuration of a conventional encryption apparatus using wired equivalent privacy (WEP);

FIG. 2 is a block diagram showing a configuration of a conventional decryption apparatus using wired equivalent privacy (WEP);

FIG. 3 is a flowchart showing a conventional network configuration method for establishing an encryption key in a host system that doesn't have an input device;

FIG. 4 illustrates an encryption key generating method according to an embodiment of the present invention;

FIG. 5 is a flowchart showing operations of the encryption key generating method according to the embodiment of FIG. 4; and

FIG. 6 is a block diagram showing an apparatus running the encryption key generating method of FIGS. 4 and 5, according to another embodiment of the present invention.

FIG. 7 illustrates a client system capable of receiving an encryption key generated by the method of FIGS. 4 and 5, according to another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

In order to solve the above-described problems, the present invention provides a method of generating an encryption key which guarantees security by establishing a WEP key based on a pre-designated number corresponding to a host apparatus and a dip switch manipulated by a user. The present invention also provides an apparatus to run the encryption key generating method described above.

FIG. 4 illustrates an encryption key generating method according to an embodiment of the present invention.

A host system can include a dip switch to generate a WEP key. An encryption key can be obtained by associating a pre-designated number corresponding to the host system with a current value of the dip switch, and inputting the associated value into a predetermined encryption key generating algorithm.

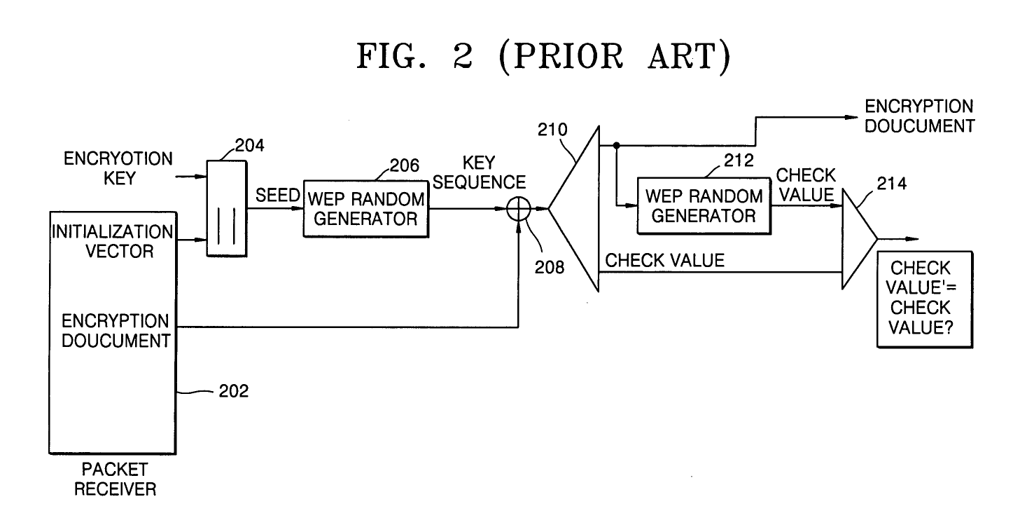

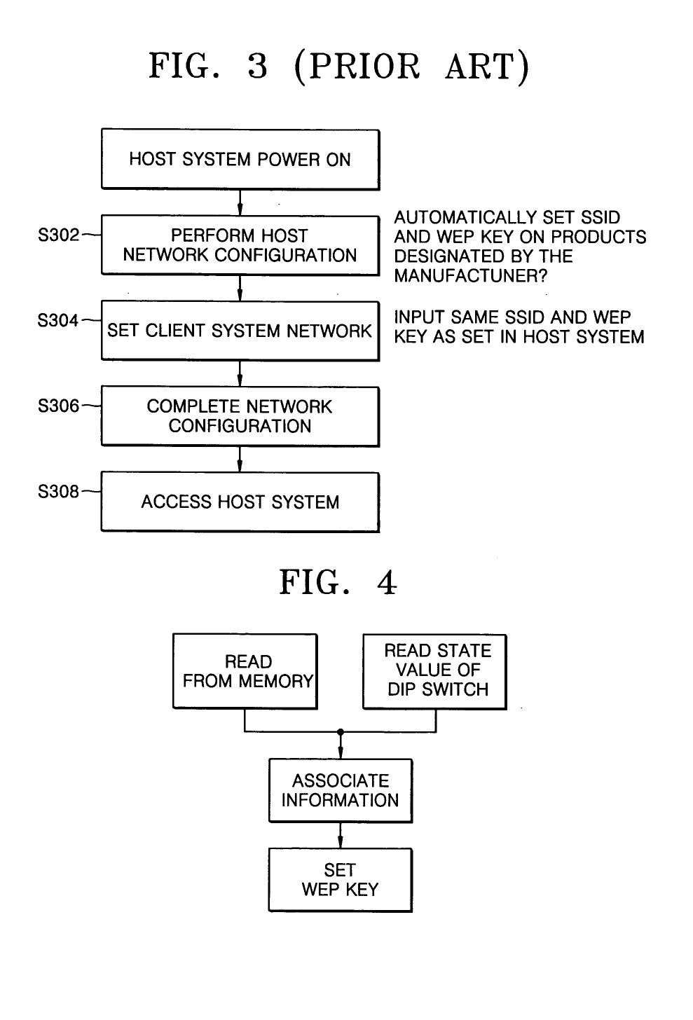

A set of values obtained by associating the pre-designated number corresponding to the host system with the current value of the dip switch can be provided by a manufacturer in advance in the form of a printed table. A user can look up an encryption key, corresponding to the current value established in the dip switch, in the printed table. Accordingly, if a network configuration is accomplished by using the encryption key obtained by the host system, a client system similar to one illustrated in FIG. 2 can receive a signal transmitted from the host system.

In a situation where the pre-designated number of the host system is three digits, and a 3-bit dip switch is used, it is possible to establish a total of 64 encryption keys. A printed table showing a WEP key for each case can be provided. The number of possible WEP keys increases exponentially according to the number of digits of the pre-designated number of the host system and the number of bits of the dip switch. Thus, security can be increased as compared to the situation where an encryption key is set by a manufacturer.

The pre-designated number of the host system is not externally exposed with respect to the host system unless an internal memory of the host system is accessed. Since the setting of the dip switch is done by a user, the encryption key can be changed anytime by the user as necessary.

According to the encryption key generating method of FIG. 4, an encryption key can be generated by using the unique non-externally exposed, pre-designated number of the host system and the dip switch setting established by the user. Accordingly, even though a host system doesn't have an input device such as, for example, a keyboard, to establish a WEP key, security can be increased.

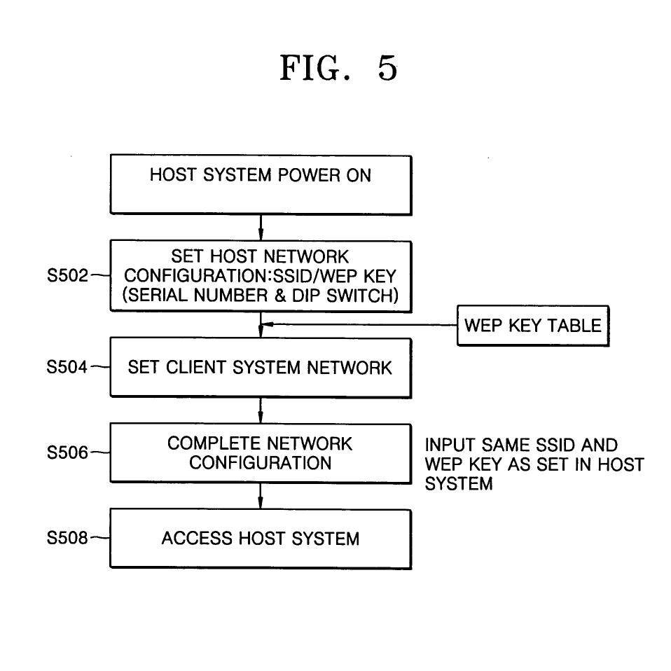

FIG. 5 is a flowchart showing an encryption key generating method that can generate a WEP key according to an embodiment of the present invention.

First, a host system can set up its network configuration by using its own pre-designated number and the current value of a dip switch established by a user after it is powered on, in operation S502. The host system can read the pre-designated number from memory, read the current value of the dip switch, and can associate the pre-designated number with the current value, and can then input the associated value into an encryption key generator to generate a WEP key, thereby allowing the network to be configured with the generated WEP key.

The pre-designated number of the host system is a number which is assigned only to the corresponding host apparatus. For example, the pre-designated number of the host system can be, for example, a MAC address of a network interface card installed in the host system, a manufacturing serial number of the host system, and so on. The MAC address and the manufacturing serial number of the host system can be stored in a non-volatile memory installed in the host system and can be referenced during the generation of the WEP key. The current value of the dip switch can be read via a GPIO port in a microprocessor.

A client system can accomplish the network configuration based on the SSID and a WEP key established in the host system, in operation S504.

If the network configuration is completed in the client system, the host system can be accessed, in operations S506 and S508.

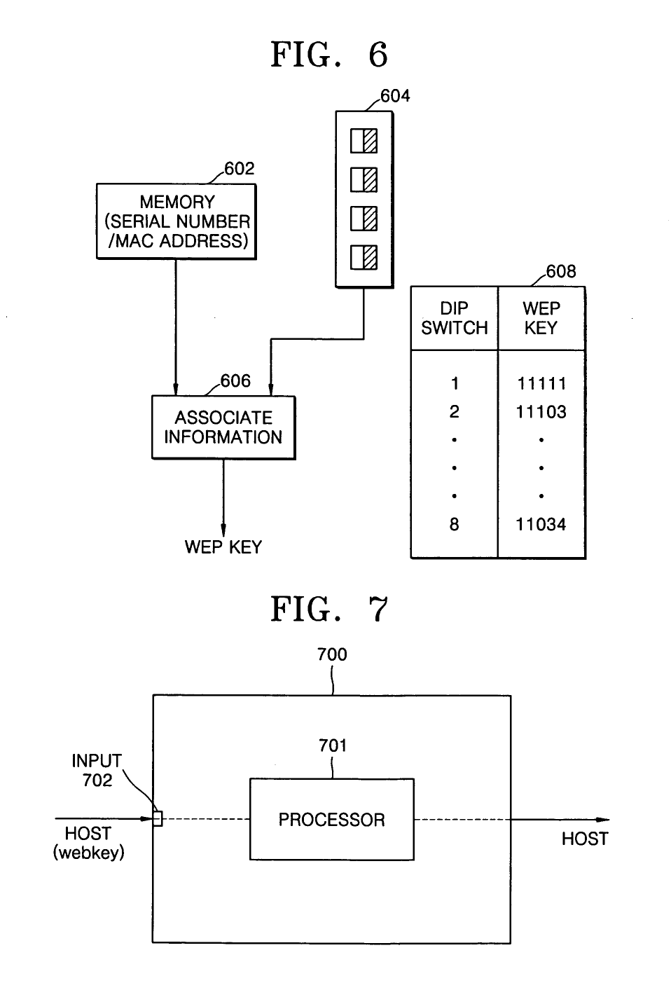

FIG. 6 is a block diagram showing an apparatus running the encryption key generating method of FIGS. 4 and 5, according to another embodiment of the present invention, and shows an example of generating a WEP key. The apparatus shown in FIG. 6 can be installed in a host system and can provide an encryption key to perform a network configuration in the host system. In FIG. 6, reference numeral 602 denotes a memory to store a pre-designated number corresponding to the host system, reference numeral 604 denotes a dip switch, and reference numeral 606 denotes an encryption key generator.

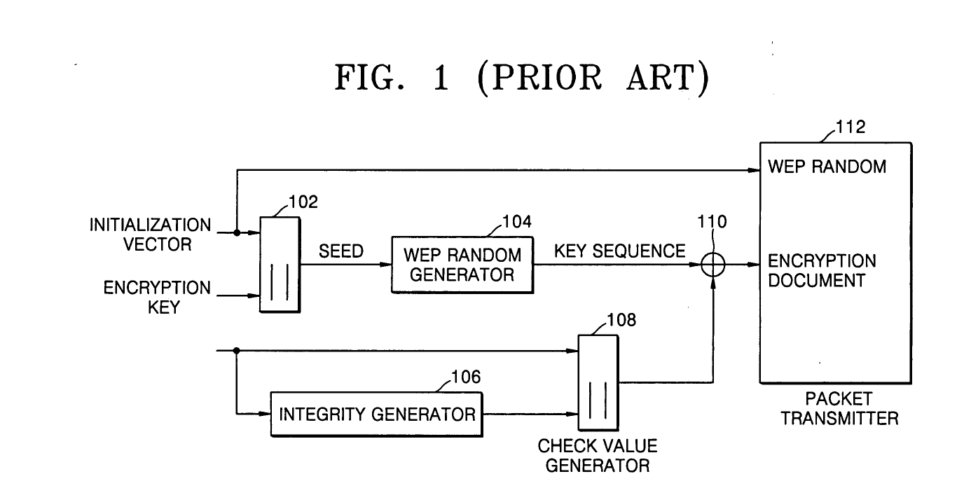

The encryption key generator 606 receives the digits of the pre-designated number of the host system that is stored in memory 602 and a current value of the dip switch 604, and generates a WEP key by using a predetermined encryption algorithm. The generated encryption key is provided to the host system, for example, to a seed generator 102 shown in FIG. 1. The dip switch 604 is a part of a host system that is widely used for various functions. For example, the dip switch can be provided to perform a channel number selection, an automatic mode selection, and so on, in a wireless transmission set-top-box. According to an embodiment of the present invention, the dip switch 604 can be used to establish a WEP key.

A printed sheet 608 having a table showing a list of WEP keys and their associated dip switch values can be provided to allow network configuration of the client system. A user can identify a WEP key from the printed sheet 608, the WEP key corresponding to the value established by way of the dip switch, and the user can input the identified WEP key into the client system when performing a network configuration.

The encryption key generating method according to FIGS. 4 and 5 can generate an encryption key by using a pre-designated number corresponding to the host system, and which is unique to each system and is not externally exposed. Furthermore, the method increases the number of possible encryption keys by using a dip switch, thereby increasing security.

FIG. 7 illustrates a client system 700 that is network configured by processing a WEB key having a designated signal and a current value corresponding to a dip switch of the host system if FIG. 6, according to another embodiment of the present invention. The client system includes an input terminal 702 connected to the host system shown in FIG. 4, to receive the WEB key from a block “SET WEP KEY” through a communication line such as the Internet, telephone line, or a wireless communication line, and a processor 701 to decript the WEB key having a designated signal and a current value corresponding to a dip switch of the host system described in FIG. 6.

Although a few embodiments of the present invention have been shown and described, it will be appreciated by those skilled in the art that changes may be made in these embodiments without departing from the principles and spirit of the invention, the scope of which is defined in the appended claims and their equivalents.

1. An encryption key generating method performed in a network environment including a host system that transmits an encrypted signal and a client system that receives the encrypted signal and decrypts the received signal by using an encryption key established in the host system, the encryption key generating method comprising:
reading a pre-designated number corresponding to the host system;
reading a current value of a dip switch installed in the host system;
associating the pre-designated number with the current value to generate an associated value; and
generating an encryption key in a wireless LAN environment by using the associated value.

2. The encryption key generating method of claim 1, wherein the pre-designated number is a manufacturing serial number of the host system.

3. The encryption key generating method of claim 1, wherein the pre-designated number is a MAC address of a wireless transmission device included in the host system.

4. The encryption key generating method of claim 1, wherein the network environment is a wireless network and the encryption key is a WEP key.

5. An encryption key generating apparatus having a host system that transmits an encrypted signal to a client system, which receives the encrypted signal transmitted from the host system and decrypts the received encrypted signal by using an encryption key determined in the host system, the encryption key generating apparatus comprising:
a memory arranged to store a pre-designated number corresponding to the host system;
a dip switch arranged in the host system; and
an encryption key generator arranged to receive the pre-designated number corresponding to the host system and a current value of the dip switch, and is capable of generating an encryption key that the host system uses to configure a network.

6. The encryption key generating apparatus of claim 5, wherein the pre-designated number is a serial number of the host system.

7. The encryption key generating apparatus of claim 5, wherein the pre-designated number is a MAC address of a network interfacer included in the host system.

8. The encryption key generating apparatus of claim 5, further comprising a printed matter having a table showing a list of WEP keys and a list of corresponding current values of the dip switch to provide a network configuration for the client system.

9. The encryption key generating apparatus of claim 5, wherein the network is a wireless network and the encryption key is a WEP key.

10. A method of generating an encryption key in a network including a host system and a client system, the method comprising:
reading a current value of a dip switch of the host system;
reading a pre-designated number corresponding to the host system;
associating the pre-designated number corresponding to the host system with the current value of the dip switch and generating an associated value; and
generating an encryption key by using the associated value.

11. The method of claim 10, wherein generating an encryption key includes inputting the associated value into an encryption key generating algorithm.

12. The method of claim 10, wherein the pre-designated number is a serial number of the host system.

13. The method of claim 10, wherein the pre-designated number is a MAC address of a wireless transmission device host system.

14. The method of claim 10, wherein the network is a wireless network and the encryption key is a WEP key.

15. The method of claim 10, further comprising configuring the network by providing the encryption key to the host system.

16. The method of claim 10, further comprising configuring the network by providing the encryption key to the client system.

17. A method of configuring a network including a host system and a client system, the method comprising:
generating an encryption key including:
reading a current value of a dip switch of the host system,
reading a pre-designated number corresponding to the host system,
associating the pre-designated number with the current value and generating an associated value, and
generating an encryption key by using the associated value;
providing the encryption key to the host system to configure the host system with the network; and
providing the encryption key to the client system to configure the client system with the network.

18. The method of claim 17, wherein providing the encryption key to the client system includes determining the encryption key from a printed table.

19. An encryption key generating apparatus to configure a network including a host system, the apparatus comprising:
a memory having a pre-designated number stored therein corresponding to the host system;
a dip switch having a plurality of switchable values; and
an encryption key generator arranged to receive the pre-designated number corresponding to the host system and a current value of the dip switch and being capable of generating an encryption key.

20. The apparatus of claim 19, wherein the encryption key generator includes an encryption algorithm program that generates the encryption key from the predetermined number corresponding to the host system and the current value of the dip switch.

21. A network comprising:
a host system including an encryption key generating apparatus including:
a memory having a pre-designated number stored therein corresponding to the host system,
a dip switch having a plurality of switchable values, and
an encryption key generator arranged to receive the pre-designated number corresponding to the host system and a current value of the dip switch and to generate an encryption key that configures the host system to the network; and
a client system including an input and capable of being configured to the network by entering the encryption key into the input.

22. The network of claim 21, wherein the network is a wireless network and the encryption key is a WEP key.

23. The network of claim 21, wherein the dip switch is manipulatable by a user.

24. The network of claim 21, wherein the host system does not include an input device.

25. A client system to communicate with a host system to configure a network, comprising:
an input terminal to receive a WEB key from the host system, the WEB key having a designated signal and a current value corresponding to a dip switch of the host system; and
a processor to configure the network according to the designated signal and the current value of the WEB key.

26. The client system of claim 25, wherein the WEB key is not a random signal.
